(19) United States
(12) Patent Application Publication
(10) Pub. No.: US 2024/0293779 A1
(43) Pub. Date: Sep. 5, 2024

(54) CHLOR-ALKALI ELECTRODIALYSIS FOR LITHIUM EXTRATION FROM GEOTHERMAL FLUIDS

(71) Applicant: Board of Regents, The University of Texas System, Austin, TX (US)

(72) Inventors: Hermann Lebit, El Paso, TX (US); Benjamin Brunner, El Paso, TX (US)

(21) Appl. No.: 18/426,316

(22) Filed: Jan. 29, 2024

Related U.S. Application Data
(60) Provisional application No. 63/488,418, filed on Mar. 3, 2023.

(51) Int. Cl. B01D 61/46; C25B 1/46; C25B 9/19; C25B 15/08

(52) U.S. Cl. CPC B01D 61/463; B01D 61/464; C25B 1/46; C25B 9/19; C25B 15/087

(57) ABSTRACT

Embodiments of this disclosure use ion-selective electrodialysis to separate ions from geothermal brines, leading to an enrichment and isolation of lithium while concurrently producing hydrogen and chlorine gas (chlor-alkali electrodialysis) and capturing carbon dioxide gas in the form of carbonate. An electrodialysis apparatus can include seven compartments or tanks, one anode, two cathodes, and non-selective and valent-selective ion exchange membranes to yield lithium carbonate. This technology can be extended with additional electrodialysis apparatus to yield lithium hydroxide.

### CROSS-REFERENCE TO RELATED APPLICATION

Referring to the application data sheet filed herewith, this application claims a benefit of priority under 35 U.S.C. 119(e) from co-pending provisional patent application U.S. Ser. No. 63/488,418, filed Mar. 3, 2023, the entire contents of which are hereby expressly incorporated herein by reference for all purposes.

### BACKGROUND INFORMATION

### 1. Field

The present invention relates generally to the field of electrodialysis. More particularly, it concerns apparatus and methods of chlor-alkali electrodialysis for lithium extraction from geothermal fluids such as geothermal brine.

### 2. Background

Due to its use in light-weight batteries used in electric vehicles, demand for lithium keeps increasing, and so does the price for this commodity. Economically favorable extraction of lithium from aqueous solutions and rocks is critical to increasing lithium supply. Similarly, fueling expanding research on lithium extraction while large projects for lithium extraction are underway is critical.

There is a plethora of approaches for lithium extraction, ranging from precipitation and physicochemical removal of contaminants and subsequent extraction of lithium via mineral precipitation steps to membrane-based separation of lithium, whereby the latter approaches often also involve the former approaches. In recent years, membrane-based approaches have made considerable progress, and numerous promising applications for lithium extraction have been proposed. Currently, no leading ‘best’ technology can be identified with confidence. Therefore, the method of choice must be selected based on criteria that consider how it benefits not just lithium extraction, but the economy of an overall process.

In the context of the greater El Paso region, feed solutions could be fluids produced from geothermal energy production (likely brackish waters) and extraction of oil and gas (typically saline brine). Considering that H₂ is going to be the energy carrier of the future, a lithium extraction process that generates H₂ and consumes CO₂ that, for example is produced by H₂ generation via steam reforming of hydrocarbons is favorable.

While geothermal fluids in the Imperial Valley of California are a significant lithium resource, the expected increase in demand by as much as 500% by 2050 highlights the need to access additional sources. Those include closed basins, lithium clays, oilfield brines and geothermal brines. Leveraging the geothermal potential and the chemical composition of produced reservoir fluids can be applicable to basins across the nation and the world. In this context, identifying and de-risking sites for sampling and field tests is an integral part of the technology development for direct lithium extraction from geothermal brine as it will provide real-life brine samples to prove the technology feasibility. Geothermal fluids will be retrieved from existing wells, predominately in hydrocarbon basins which are selected based on advanced play fairway analysis.

Existing technology of Li extraction uses large amounts of water (evaporation process) and is currently restricted to few locations on the globe. What is needed is a technique that uses comparably less water and simultaneously improves water quality (desalination) while sequestering carbon dioxide and producing commodities such as hydrogen gas (a green fuel) and chlorine gas. The combination of these economically and ecologically positive outcomes presents a massive benefit over other existing technology. Thus, there is a demand for technology that achieves these goals, producing a new paradigm for geothermal energy production nationally and globally.

### SUMMARY

Geothermal operations produce enormous volumes of lithium-bearing fluids that are primarily used only for their ability to generate electric power. Generated electricity can be leveraged to extract lithium from the brine, produce green hydrogen and other commodities, and sequester carbon dioxide (CO₂)—all with a higher economic return than electrical production alone and with a limited operational footprint. The combination of these outcomes in an embodiment of this disclosure advances the viability of geothermal energy production and the transition from carbon-based fuels.

Embodiments of this disclosure provide solutions to the following issues: —separation of lithium from divalent cations, in particular magnesium —desalination of water-production of ‘CO2-neutral’ hydrogen gas-sequestration of carbon dioxide. In a commercialized form, embodiments of this disclosure can be developed the serve as modular building block for geothermal energy production which produces vast amounts of saline water, as well as for the conversion of produced waters from oil/gas field in combination with carbon dioxide capture for steam reforming plants that aim to produce climate-neutral hydrogen gas.

An illustrative embodiment of the present disclosure is an apparatus for chlor-alkali ion-selective electrodialysis production of lithium hydroxide, comprising: a first compartment comprising an anode; an anion-exchange membrane coupled to the first compartment; a second compartment coupled to the anion-exchange membrane; a first cation-exchange membrane coupled to the second compartment; a third compartment coupled to the first cation-exchange membrane, the third compartment comprising a first cathode; a fourth compartment coupled to the third compartment; a monovalent selective cation-exchange membrane coupled to the third compartment; a fifth compartment coupled to the monovalent selective cation-exchange membrane, the fifth compartment comprising a second cathode; a sixth compartment coupled to the fifth compartment; a seventh compartment coupled to both the sixth compartment and the fifth compartment; an eight compartment comprising another anode; a second cation-exchange membrane coupled to the eight compartment; a ninth compartment coupled to both the second cation-exchange membrane and the sixth compartment; a third cation-exchange membrane coupled to the ninth compartment; a tenth compartment coupled to the third cation-exchange membrane, the tenth compartment comprising a third cathode; and an eleventh compartment coupled to the tenth compartment.

Another illustrative embodiment of the present disclosure is a method of chlor-alkali ion-selective electrodialysis, comprising: circulating a first compartment electrolyte through a first compartment, the first compartment electrolyte comprising HCl, the first compartment comprising an anode; circulating a geothermal fluid through a second compartment; migrating Cl⁻ and SO₄²⁻ through an anion-exchange membrane from the second compartment into the first compartment; migrating Na⁺, Li⁺, Ca²⁺ and Mg²⁺ through a first cation-exchange membrane from the second compartment into a third compartment containing a third compartment electrolyte, the third compartment comprising a first cathode; circulating the third compartment electrolyte through a fourth compartment; precipitating magnesium carbonate and calcium carbonate from the third compartment electrolyte while the third compartment electrolyte is in the fourth compartment, wherein a fourth compartment temperature of the third compartment electrolyte is higher than a third compartment temperature of the third compartment electrolyte; migrating Na⁺ and Li⁺ through a monovalent selective cation-exchange membrane from the third compartment into a fifth compartment containing a fifth compartment electrolyte, the fifth compartment comprising a second cathode; circulating the fifth compartment electrolyte through a sixth compartment; precipitating lithium carbonate from the fifth compartment electrolyte while the fifth compartment electrolyte is in the sixth compartment, wherein a sixth compartment temperature of the fifth compartment electrolyte is higher than a fifth compartment temperature of the fifth compartment electrolyte; circulating the fifth compartment electrolyte through a seventh compartment; precipitating sodium hydroxide from the fifth compartment electrolyte while the fifth compartment electrolyte is in the seventh compartment, wherein a seventh compartment temperature of the fifth compartment electrolyte is lower than the fifth compartment temperature of the fifth compartment electrolyte; migrating H⁺ through a secondary cation-exchange membrane from an eight compartment containing an eight compartment electrolyte to a ninth compartment containing a ninth compartment electrolyte, the eight compartment comprising another anode; conveying lithium carbonate from the sixth compartment to the ninth compartment; migrating Li⁺ through a third cation-exchange membrane from the ninth compartment to a tenth compartment containing a tenth compartment electrolyte, the tenth compartment comprising a third cathode; circulating the tenth compartment electrolyte through an eleventh compartment; and precipitating lithium hydroxide from the tenth compartment electrolyte while the tenth compartment electrolyte is in the eleventh compartment, wherein an eleventh compartment temperature of the tenth compartment electrolyte is lower than a tenth compartment temperature of the tenth compartment electrolyte.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-1B are schematic illustrations of chlor-alkali electrodialysis for lithium extraction from geothermal fluid in accordance with an exemplary embodiment of this disclosure.

### DETAILED DESCRIPTION

Fluids produced from geological reservoirs contain cations such as sodium (Na⁺), potassium (K⁺), calcium (Ca²⁺), magnesium (Mg²⁺), strontium (Sr²⁺), barium (Ba²⁺), and anions such as chloride (Cl⁻), sulfate (SO₄²⁻), carbonate (CO₃²⁻). Separation of these constituents, in particular extraction of lithium (Li⁺), is challenging, but can be overcome by employing modified ion-selective electrodialysis (ED) combined with the formation of carbonate at cathodes.

Embodiments of this disclosure can separate lithium from brines as a part of an ecologically and economically viable system in which CO₂ is captured and green hydrogen gas, along with valuable byproducts, are recovered. Embodiments of this disclosure can utilize energy industry infrastructure and workflows to capture lithium-rich geothermal resources to diversify the growing domestic supply of battery-graded lithium.

Embodiments of this disclosure can simultaneously produce commodities such as lithium carbonate, lithium hydroxide, green hydrogen, chlorine, and sodium hydroxide while sequestering CO₂ in a setting where geothermal energy is produced-enhancing economic return and enabling environmentally friendly small-footprint production of commodities. This combination of features is an important commercial advantage of embodiments of this disclosure.

The apparatus is based on modified ion-selective electrodialysis (ED) combined with the formation of carbonate at cathodes. Unique to embodiments of this disclosure is that the methodology combines i) lithium extraction, ii) carbon dioxide sequestration, and iii) hydrogen gas production-perfectly suited to the needs of the Energy Transition, which needs lithium for batteries, hydrogen gas as a greenhouse-gas neutral fuel, and aims to reduce carbon dioxide emissions to the atmosphere.

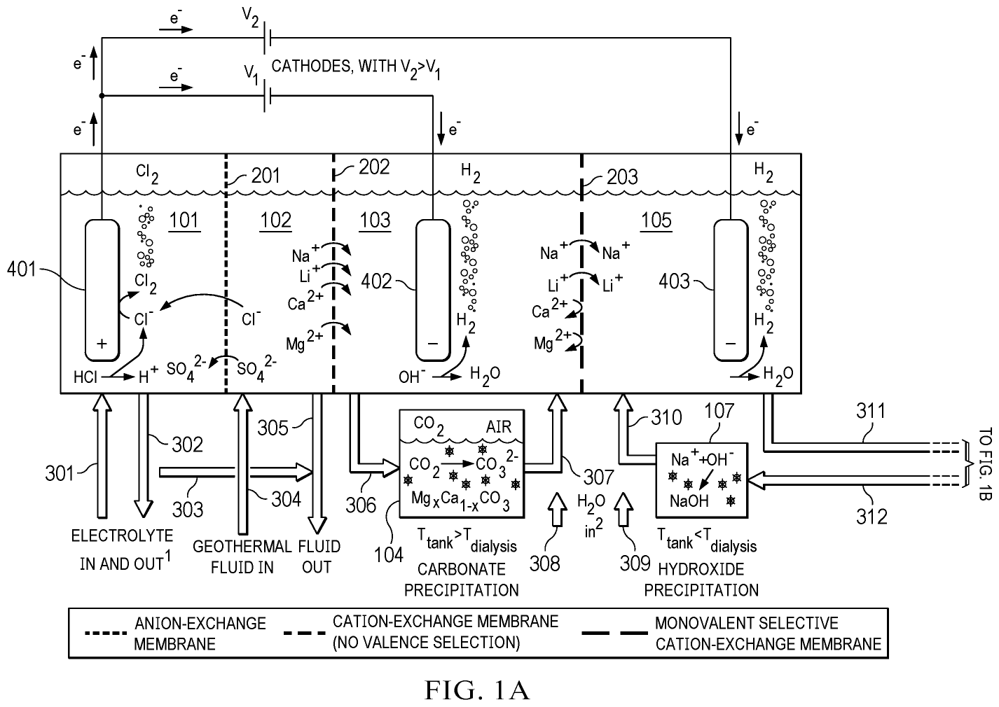

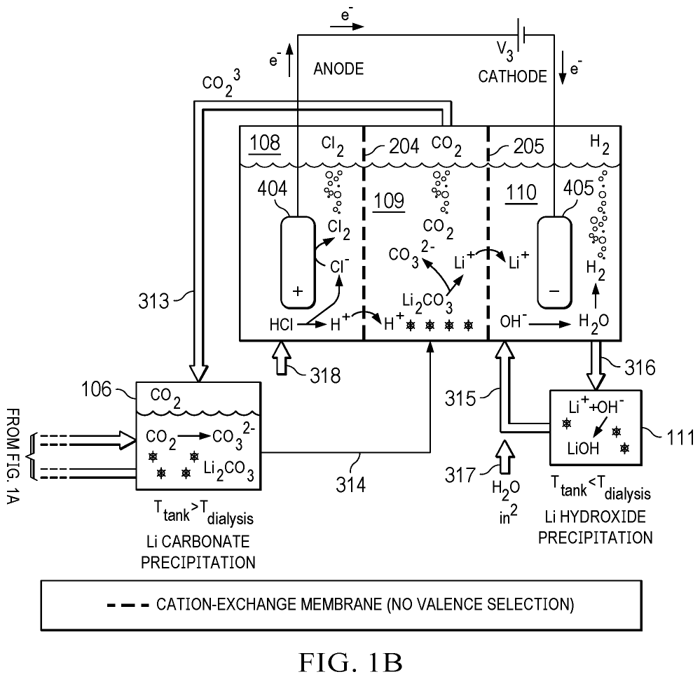

Embodiments of this disclosure can make use of chlor-alkali ion-selective electrodialysis combined with the precipitation of lithium carbonate, followed by conversion of lithium carbonate to lithium hydroxide, again using chlor-alkali electrodialysis. Referring to FIGS. 1A-1B, embodiments of this disclosure can include applying electric potentials; the apparatus produces chlorine (Cl₂) gas and protons (low pH, compartments 101 and 108) at two anodes and hydrogen gas (H₂) and hydroxide ions (high pH) at three cathodes (compartments 103, 105, 110).

FIGS. 1A-1B show an apparatus for lithium hydroxide extraction from geothermal fluids. In particular, this is an apparatus for chlor-alkali ion-selective electrodialysis production of lithium hydroxide. The apparatus includes a first compartment 101 comprising an anode 401. An anion-exchange membrane 201 coupled to the first compartment 101. A second compartment 102 is coupled to the anion-exchange membrane 101. A first cation-exchange membrane 202 is coupled to the second compartment 102. A third compartment 103 is coupled to the first cation-exchange membrane 202. The third compartment 103 includes a first cathode 402. A fourth compartment 104 (tank) is coupled to the third compartment. A monovalent selective cation-exchange membrane 203 is coupled to the third compartment 103. A fifth compartment 105 is coupled to the monovalent selective cation-exchange membrane 203. The fifth compartment 105 includes a second cathode 403. A sixth compartment 106 (tank) is coupled to the fifth compartment 105. A seventh compartment 107 (tank) is coupled to both the sixth compartment 106 and the fifth compartment 105. An eight compartment 108 includes another anode 404. A second cation-exchange membrane 204 is coupled to the eight compartment 108. A ninth compartment 109 is coupled to both the second cation-exchange membrane 204 and the sixth compartment 106. A third cation-exchange membrane 205 is coupled to the ninth compartment 109. A tenth compartment 110 is coupled to the third cation-exchange membrane 205. The tenth compartment 110 includes a third cathode 405. An eleventh compartment 111 (tank) is coupled to the tenth compartment.

Still referring to FIGS. 1A-1B, an electrolyte inlet 301 is coupled to the first compartment and an electrolyte output 302 coupled to the first compartment. A geothermal fluid inlet 304 is coupled to the second compartment and a fluid outlet 305 is coupled to the second compartment. A third compartment electrolyte outlet 306 is coupled between the third compartment 103 and the fourth compartment 104 and a third compartment electrolyte inlet 307 is coupled between the fourth compartment 104 and the third compartment 103. A source of water 308 is coupled to the third compartment electrolyte inlet 307. A fifth compartment electrolyte outlet 311 is coupled between the fifth compartment 105 and the sixth compartment 106, a conduit 312 is coupled between the sixth compartment 106 and the seventh compartment 107, and a fifth compartment electrolyte inlet 310 is coupled between the seventh compartment 107 and the fifth compartment 105. A source of water 309 is coupled to the fifth compartment electrolyte inlet 310. A first mechanical connection 314 is connected between the sixth compartment 106 and the ninth compartment 109 to convey lithium carbonate to the ninth compartment 109. There is a second mechanical connection 313 between the ninth compartment 109 and the sixth compartment 106 to convey carbon dioxide to the sixth compartment 106. A tenth compartment electrolyte outlet 316 is coupled between the tenth compartment 110 and the eleventh compartment 111 and a tenth compartment electrolyte inlet 315 is coupled between the eleventh compartment 111 and the tenth compartment 110. A source of water 317 is coupled to the tenth compartment electrolyte inlet 315. A source of geothermal energy can be thermally connected, particularly to the fourth compartment 104 and the sixth compartment 106.

In FIGS. 1A-1B the superscripts are intended to have the following meanings. ¹The addition of hydrochloric acid in compartment 1 serves to maintain ion balance accounting for the influx of anions from the geothermal fluid, for example, per sulfate ion two units of hydrochloric acid are supplied, resulting in the generation of sulfuric acid (H₂SO₄). To maintain low acid levels, this electrolyte can be purged into the ion-depleted geothermal fluid output. ²Addition of H₂O serves to compensate the loss of hydrogen and increases the solubility of salts. ³The production of CO₂ from lithium carbonate dissolution matches the CO₂ consumption by lithium carbonate precipitation.

In electrodialysis cells, ion migration is controlled by voltage gradients and placement of ion-selective membranes (201-205). In the first stage of the apparatus (FIG. 1A) migration of ions proceeds as follows. A saline geothermal feed solution enters compartment 102, where anions (i.e., chloride, Cl⁻ and sulfate, SO₄²⁻, but other anions, such as HCO₃⁻, CO₃²⁻, and H₃Si₄⁻ will be present) migrate toward the anode (compartment 101), whereas cations, such as sodium (Na⁺), potassium (K⁺), lithium (Li⁺) calcium (Ca²⁺), magnesium (Mg²⁺), and strontium (Sr²⁺), migrate toward the cathodes (compartments 103 and 105). A monovalent selective ion-exchange membrane 203 located between the two cathodic compartments 103, 105 is employed to retain divalent (M²⁺) and higher valence ions in the first cathode compartment 103, whereas monovalent ions (i.e., Na⁺, K⁺, Li⁺), are collected in an electrodialysis compartment 105 that contains the second cathode 403. Monovalent ion migration through the monovalent selective cation-exchange membrane 203 is promoted by a higher electrical potential of the second cathode 403 (V₂>V₁).

Multivalent ions in the first cathode compartment 103 are removed by circulating fluids through an external tank 104 that is in contact with the atmosphere and is kept at a higher temperature than the first stage of the apparatus. This ensures that carbonate minerals are less soluble in tank 104 than in compartment 103 (note: carbonates are less soluble at higher T). Atmospheric CO₂ dissolves in the basic solution, resulting in precipitation of divalent and higher-valent carbonates (e.g., MgₓCa₁₋ₓCO₃) in the external tank 104, preventing precipitation of these minerals on the cathode by maintaining under-saturation of carbonate minerals in the cooler dialysis compartment. The high pH and presence of carbonate ions ensures that concentrations of divalent cations are kept low and impede formation of monovalent bicarbonate species (MHCO₃⁺) in the first cathode compartment 103 preventing their migration through the monovalent selective cation-exchange membrane into the second cathode compartment 105.

Fluids from the compartment 105 with the second cathode 403 are similarly circulated through a tank 106 that is kept at a higher temperature (+70° C.) than the first stage of the apparatus (+50° C.). Carbon dioxide, derived from the second stage of the apparatus (FIG. 1B), dissolves in the basic solution, converts into carbonate ions and precipitates as lithium carbonate (Li₂CO₃). The solution is then passed through another tank 107 that is kept at a temperature below the first tank stage (+30° C.) allowing for the collection of hydroxide salts (i.e., NaOH), and finally transferred back into the second cathode compartment 105. Lower solubility of lithium carbonate at higher temperature (compartment 106) and lower solubility of hydroxides at lower temperature (compartment 107) ensures separation of lithium from sodium and prevents their precipitation on the second cathode by maintaining respective under-saturation in compartment 105.

Lithium carbonate is then physically transferred to the second stage of the apparatus (FIG. 1B) into a center compartment 109 which is separated from the anode compartment 108 and cathode compartment 110 by cation exchange membranes 204 and 205. Chlorine (Cl₂) gas production at the anode 404 in compartment 108 increases acidity and promotes migration of protons into the center compartment 109, where it triggers the dissolution of lithium carbonate and formation of CO₂, which is supplied to the lithium precipitation process in the first stage of the apparatus. Generation of hydrogen gas (H₂) and hydroxide (high pH) at the cathode 405 in compartment 110 in combination with lithium migration from compartment 109 drives lithium hydroxide concentrations towards saturation. To precipitate lithium hydroxide (LiOH), fluid from compartment 110 is circulated through a tank 111 that is kept at a temperature (+30° C.) below the one of the second stage (+50° C.) of the apparatus allowing for the collection of hydroxide salts (i.e., LiOH), and residual fluid is transferred back into the third cathode 405 compartment 110. The lower solubility of lithium hydroxide at lower temperatures (compartment 111) maintains under-saturation of LiOH in compartment 110, to which the residual fluid is returned.

### Examples

Specific exemplary embodiments will now be further described by the following, nonlimiting examples which will serve to illustrate in some detail various features. The following examples are included to facilitate an understanding of ways in which embodiments of the present disclosure may be practiced. However, it should be appreciated that many changes can be made in the exemplary embodiments which are disclosed while still obtaining like or similar result without departing from the scope of embodiments of the present disclosure. Accordingly, the examples should not be construed as limiting the scope of the present disclosure.

### 1. Apparatus Material

The apparatus material (e.g., frames, bulkheads, balance of plant) can be made from high-strength non-corrosive plastics (PTFE and PP) as well as stainless steel.

### 2. Electrodes

Anode 401 in compartment 101 and another anode 404 in compartment 108 can be mixed metal oxide electrodes (MMO), also referred to as dimensionally stable anodes (DSA)—titanium plate coated with ruthenium, iridium oxide (RuO+IrO).

The first cathode 402 in compartment 103, the second cathode 403 in compartment 105 and the third cathode 405 in compartment 110 can be nickel-based or iron-nickel based electrodes.

### 3. Membranes

Anion-exchange membrane 201 can be made of polystyrene cross linked with divinylbenzene with quaternary ammonium functional group (e.g., AXM-100S anion exchange membranes) or imidazolium-functionalized styrene and vinylbenzyl chloride (VBC) based polymers (tradenamed Sustainion™).

First cation-exchange membrane 202, second cation-exchange 204, and third cation-exchange 205 can be made of sulphonated polymer material such as PTFE (e.g., Nafion™ chor-alkali membranes) or polystyrene cross linked with divinylbenzene with sulphonic acid functional group (e.g., CXM-200S).

Monovalent selective cation-exchange membrane 203 can be made of sulfonated or quarternerized aromatic polymer material. Examples of commercially available membranes: Fuji Film, NeoSepta/Astom, IonFlux™ mAEM.

### 4. Operating Parameters

The pressure (entire apparatus) can be from approximately ambient (˜1 bar) to approximately ambient+2 bar pressure.

### Temperature (in Kelvin K)

Compartments 101, 102, 103, 105, 108, 109 and 110 (two main electrodialytic cells=T_{dialysis}):

$${T}_{dialysis} = 321 \pm 12.5 K$$

Tanks 104 and 106, with T_{tank_104_106}>T_{dialysis}:

$${T}_{tank\_ 104 \_ 106} = {T}_{dialysis} + 20 \pm 10 K$$

Tanks 107 and 111, with T_{tank_107_111}<T_{dialysis}:

$${T}_{tank\_ 107 \_ 111} = {T}_{dialysis} - 20 \pm 10 K$$

pH
Compartment 1: pH 1 to 7
Compartment 2: pH of entering geothermal fluid, expected range pH 6 to 8
Compartment 3: pH 8.5 to 11
Tank 4: pH 8.5 to 11
Compartment 5: pH 8.5 to 11
Tank 6: pH 8.5 to 11
Tank 7: pH 8.5 to 11
Compartment 8: pH 1 to 5
Compartment 9: pH 5 to 7
Compartment 10: pH 8.5 to 11
Tank 11: pH 8.5 to 11
   Residence Time (t_{R})/Flow Rates

Flow rates are provided relative to residence time, i.e., the residence time of fluid parcel is the total time that the parcel has spent inside a control volume. Flow rates thus scale with the dimension of the volume of compartments.

### Compartment 1:

t_{R} for electrolyte (HCl-solution) 1 hr to 48 hrs (higher flow rates for geothermal brines with high sulfate content)

### Compartment 2:

t_{R} for geothermal fluid (HCl-solution) 1 hr to 24 hrs (lower flow rates at higher lithium content)

### Compartment 3:

t_{R} for fluid 1 hr to 24 hrs (lower flow rates at low content of multivalent cations)

### Tank 4:

t_{R} for fluid 10 hrs to 1 week (controlled by precipitation rate of carbonates, which is a function of temperature and multivalent cation content; relationship of t_{R} for compartment 3 and tank 4 is maintained by adjusting size of tank 4)

### Compartment 5:

t_{R} for fluid 1 hr to 24 hrs (lower flow rates at low content of monovalent cations)

### Tank 6:

t_{R} for fluid 10 hrs to 1 week (controlled by precipitation rate of lithium carbonate, which is a function of temperature and lithium content; relationship of t_{R} for compartment 5 and tank 6 is maintained by adjusting size of tank 6)

### Tank 7:

t_{R} for fluid 10 hrs to 1 week (controlled by precipitation rate of hydroxides, which is a function of temperature and monovalent cation content; relationship of t_{R} for compartment 5 and tank 7 is maintained by adjusting size of tank 7)

### Compartment 8:

t_{R} for fluid supply such as to match chlorine production

### Compartment 9:

No fluid flow, but physical addition of lithium carbonate

### Compartment 10:

t_{R} for fluid 1 hr to 24 hrs (lower flow rates at low content of lithium cations)

### Tank 11:

pH 8.5 to 11:
t_{R} for fluid 10 hrs to 1 week (controlled by precipitation rate of lithium hydroxide, which is a function of temperature and lithium cation content; relationship of t_{R} for compartment 10 and tank 11 is maintained by adjusting size of tank 11)

### Carbon Dioxide Exchange

Note on carbon dioxide gas exchange (CO₂) between compartment 109 and tank 106: The carbon dioxide gas exchange can be controlled by adjusting diameter of connecting tube 313, maintaining a pH range of 8.5 to 11 for tank 106.

### Water Supply

Note on water supply to cathode compartments (3, 5, and 10):

Water addition will be controlled such that it compensates water loss due to hydrogen production.

Although the terms compartment and tank can be used interchangeably, typically the term compartment refers to a vessel that is directly involved in electrodialysis and the term tank refers to a vessel that is not directly involved in electrodialysis and is maintained at a different temperature.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit, and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. An apparatus for chlor-alkali ion-selective electrodialysis production of lithium carbonate, comprising:
a first compartment comprising an anode;
an anion-exchange membrane coupled to the first compartment;
a second compartment coupled to the anion-exchange membrane;
a first cation-exchange membrane coupled to the second compartment;
a third compartment coupled to the first cation-exchange membrane, the third compartment comprising a first cathode;
a fourth compartment coupled to the third compartment;
a monovalent selective cation-exchange membrane coupled to the third compartment;
a fifth compartment coupled to the monovalent selective cation-exchange membrane, the fifth compartment comprising a second cathode;
a sixth compartment coupled to the fifth compartment; and
a seventh compartment coupled to both the sixth compartment and the fifth compartment.

2. The apparatus of claim 1, further comprising an electrolyte inlet coupled to the first compartment and an electrolyte output coupled to the first compartment.

3. The apparatus of claim 1, further comprising a geothermal fluid inlet coupled to the second compartment and a fluid outlet coupled to the second compartment.

4. The apparatus of claim 1, further comprising a third compartment electrolyte outlet coupled between the third compartment and the fourth compartment and a third compartment electrolyte inlet coupled between the fourth compartment and the third compartment.

5. The apparatus of claim 4, further comprising a source of water coupled to the third compartment electrolyte inlet.

6. The apparatus of claim 1, further comprising a fifth compartment electrolyte outlet coupled between the fifth compartment and the sixth compartment, a conduit coupled between the sixth compartment and the seventh compartment, and a fifth compartment electrolyte inlet coupled between the seventh compartment and the fifth compartment.

7. The apparatus of claim 6, further comprising a source of water coupled to the fifth compartment electrolyte inlet.

8. A method of chlor-alkali ion-selective electrodialysis, comprising:
circulating a first compartment electrolyte through a first compartment, the first compartment electrolyte comprising HCl, the first compartment comprising an anode;
circulating a geothermal fluid through a second compartment;
migrating Cl⁻ and SO₄²⁻ through an anion-exchange membrane from the second compartment into the first compartment;
migrating Na⁺, Li⁺, Ca²⁺ and Mg²⁺ through a first cation-exchange membrane from the second compartment into a third compartment containing a third compartment electrolyte, the third compartment comprising a first cathode;
circulating the third compartment electrolyte through a fourth compartment; precipitating magnesium carbonate and calcium carbonate from the third compartment electrolyte while the third compartment electrolyte is in the fourth compartment, wherein a fourth compartment temperature of the third compartment electrolyte is higher than a third compartment temperature of the third compartment electrolyte;
migrating Na⁺ and Li⁺ through a monovalent selective cation-exchange membrane from the third compartment into a fifth compartment containing a fifth compartment electrolyte, the fifth compartment comprising a second cathode;
circulating the fifth compartment electrolyte through a sixth compartment;
precipitating lithium carbonate from the fifth compartment electrolyte while the fifth compartment electrolyte is in the sixth compartment, wherein a sixth compartment temperature of the fifth compartment electrolyte is higher than a fifth compartment temperature of the fifth compartment electrolyte;
circulating the fifth compartment electrolyte through a seventh compartment; and
precipitating sodium hydroxide from the fifth compartment electrolyte while the fifth compartment electrolyte is in the seventh compartment, wherein a seventh compartment temperature of the fifth compartment electrolyte is lower than the fifth compartment temperature of the fifth compartment electrolyte.

9. The method of claim 8, further comprising energizing the second cathode to a higher voltage than the first cathode.

10. The method of claim 8, further comprising providing HCl to the first compartment.

11. An apparatus for chlor-alkali ion-selective electrodialysis production of lithium hydroxide, comprising:
a first compartment comprising an anode;
an anion-exchange membrane coupled to the first compartment;
a second compartment coupled to the anion-exchange membrane;
a first cation-exchange membrane coupled to the second compartment;
a third compartment coupled to the first cation-exchange membrane, the third compartment comprising a first cathode;
a fourth compartment coupled to the third compartment;
a monovalent selective cation-exchange membrane coupled to the third compartment;
a fifth compartment coupled to the monovalent selective cation-exchange membrane, the fifth compartment comprising a second cathode;
a sixth compartment coupled to the fifth compartment;
a seventh compartment coupled to both the sixth compartment and the fifth compartment;
an eight compartment comprising another anode;
a second cation-exchange membrane coupled to the eight compartment;
a ninth compartment coupled to both the second cation-exchange membrane and the sixth compartment;
a third cation-exchange membrane coupled to the ninth compartment;
a tenth compartment coupled to the third cation-exchange membrane, the tenth compartment comprising a third cathode; and
an eleventh compartment coupled to the tenth compartment.

12. The apparatus of claim 11, further comprising an electrolyte inlet coupled to the first compartment and an electrolyte output coupled to the first compartment.

13. The apparatus of claim 11, further comprising a geothermal fluid inlet coupled to the second compartment and a fluid outlet coupled to the second compartment.

14. The apparatus of claim 11, further comprising a third compartment electrolyte outlet coupled between the third compartment and the fourth compartment and a third compartment electrolyte inlet coupled between the fourth compartment and the third compartment.

15. The apparatus of claim 14, further comprising a source of water coupled to the third compartment electrolyte inlet.

16. The apparatus of claim 11, further comprising a fifth compartment electrolyte outlet coupled between the fifth compartment and the sixth compartment, a conduit coupled between the sixth compartment and the seventh compartment, and a fifth compartment electrolyte inlet coupled between the seventh compartment and the fifth compartment.

17. The apparatus of claim 16, further comprising a source of water coupled to the fifth compartment electrolyte inlet.

18. The apparatus of claim 11, further comprising a first mechanical connection between the sixth compartment and the ninth compartment to convey lithium carbonate to the ninth compartment and a second mechanical connection between the ninth compartment to convey carbon dioxide to the sixth compartment.

19. The apparatus of claim 11, further comprising a tenth compartment electrolyte outlet coupled between the tenth compartment and the eleventh compartment and a tenth compartment electrolyte inlet coupled between the eleventh compartment and the tenth compartment.

20. The apparatus of claim 19, further comprising a source of water coupled to the tenth compartment electrolyte inlet.

21. A method of chlor-alkali ion-selective electrodialysis, comprising:
circulating a first compartment electrolyte through a first compartment, the first compartment electrolyte comprising HCl, the first compartment comprising an anode;
circulating a geothermal fluid through a second compartment;
migrating Cl⁻ and SO₄²⁻ through an anion-exchange membrane from the second compartment into the first compartment;
migrating Na⁺, Li⁺, Ca²⁺ and Mg²⁺ through a first cation-exchange membrane from the second compartment into a third compartment containing a third compartment electrolyte, the third compartment comprising a first cathode;
circulating the third compartment electrolyte through a fourth compartment;
precipitating magnesium carbonate and calcium carbonate from the third compartment electrolyte while the third compartment electrolyte is in the fourth compartment, wherein a fourth compartment temperature of the third compartment electrolyte is higher than a third compartment temperature of the third compartment electrolyte;
migrating Na⁺ and Li⁺ through a monovalent selective cation-exchange membrane from the third compartment into a fifth compartment containing a fifth compartment electrolyte, the fifth compartment comprising a second cathode;
circulating the fifth compartment electrolyte through a sixth compartment;
precipitating lithium carbonate from the fifth compartment electrolyte while the fifth compartment electrolyte is in the sixth compartment, wherein a sixth compartment temperature of the fifth compartment electrolyte is higher than a fifth compartment temperature of the fifth compartment electrolyte;
circulating the fifth compartment electrolyte through a seventh compartment;
precipitating sodium hydroxide from the fifth compartment electrolyte while the fifth compartment electrolyte is in the seventh compartment, wherein a seventh compartment temperature of the fifth compartment electrolyte is lower than the fifth compartment temperature of the fifth compartment electrolyte;
migrating H⁺ through a secondary cation-exchange membrane from an eight compartment containing an eight compartment electrolyte to a ninth compartment containing a ninth compartment electrolyte, the eight compartment comprising another anode;
conveying lithium carbonate from the sixth compartment to the ninth compartment;
migrating Li⁺ through a third cation-exchange membrane from the ninth compartment to a tenth compartment containing a tenth compartment electrolyte, the tenth compartment comprising a third cathode;
circulating the tenth compartment electrolyte through an eleventh compartment; and
precipitating lithium hydroxide from the tenth compartment electrolyte while the tenth compartment electrolyte is in the eleventh compartment, wherein an eleventh compartment temperature of the tenth compartment electrolyte is lower than a tenth compartment temperature of the tenth compartment electrolyte.

22. The method of claim 21, further comprising energizing the second cathode to a higher voltage than the first cathode.

23. The method of claim 21, further comprising providing HCl to the first compartment.

24. The method of claim 21, further comprising providing CO₂ to the sixth compartment from the eighth compartment.
